(19) United States
(12) Patent Application Publication
(10) Pub. No.: US 2013/0036029 A1
(43) Pub. Date: Feb. 7, 2013

(54) SYSTEMS AND METHODS FOR GENERATING MARKETPLACE LISTINGS

(71) Applicants: Mohan Patt, Hayward, CA (US); Nishant Asthana, San Jose, CA (US); Famous Rhodes, San Jose, CA (US); Ryan M. Tominaga, Salt Lake City, UT (US); Dan Tsuchiya, Los Gatos, CA (US)

(72) Inventors: Mohan Patt, Hayward, CA (US); Nishant Asthana, San Jose, CA (US); Famous Rhodes, San Jose, CA (US); Ryan M. Tominaga, Salt Lake City, UT (US); Dan Tsuchiya, Los Gatos, CA (US)

(73) Assignee: eBay Inc., San Jose, CA (US)

(21) Appl. No.: 13/198,487

(22) Filed: Aug. 4, 2011

(51) Int. Cl. G06Q 30/00

(52) U.S. Cl. 705/27.1

(57) ABSTRACT

A method and system generate and manage marketplace listings. In some embodiments, the method receives a product listing request from a catalog service that identifies a product associated with the catalog service. The product listing request is initiated by a distributor associated with the catalog service. The method identifies current listings for the product in a network-based marketplace and identifies completed listings for the product in the network-based marketplace. A price recommendation is generated for the product listing request based on the current listings and the completed listings.

### RELATED APPLICATION

This application is related to concurrently filed U.S. patent application Ser. No. ______, filed on Aug. ______, 2011, entitled “MARKETPLACE LISTING SYSTEMS AND METHODS”, and identified by Docket No. 2043.928US1.

### TECHNICAL FIELD

The present disclosure generally relates to data processing techniques and, more specifically, to systems and methods for generating marketplace listings.

### BACKGROUND

Advancements in computer and networking technology enable users and entities to conduct various types of transactions online via computer-based applications and systems. These advancements have caused the growth of electronic commerce, commonly referred to as “ecommerce”, and the development of network-based marketplaces that allow multiple users and entities to shop and execute various online transactions.

Some distributors of products and services use existing distribution channels that offer items through a catalog or similar listing of items. These existing catalogs may not allow a distributor to easily offer products or services through a network-based marketplace. In these situations, the distributor may manually list products or services with the network-based marketplace, which can be time-consuming and may involve additional personnel costs.

### BRIEF DESCRIPTION OF THE DRAWINGS

Some embodiments are illustrated by way of example and not limitation in the figures of the accompanying drawings.

FIG. 1 is a block diagram depicting an example environment capable of implementing the systems and methods discussed herein.

FIG. 2 is a block diagram of a marketplace listing system, in accordance with some embodiments of the present invention.

FIG. 3 is a flow diagram of a method, in accordance with an embodiment, for listing items with a network-based marketplace.

FIG. 4 is a flow diagram of a method, in accordance with an embodiment, for generating marketplace listings.

FIG. 5 is a flow diagram of a method, in accordance with an embodiment, for communicating sale and shipping information associated with items listed with a network-based marketplace.

FIG. 6 depicts, in accordance with an embodiment, example data associated with a listing template.

FIGS. 7A-7D depict, in accordance with an embodiment, various portions of an example marketplace listing.

FIG. 8 is a flow diagram of a method, in accordance with an embodiment, for generating price recommendations for marketplace listings.

FIG. 9 is a flow diagram of a method, in accordance with an embodiment, for recommending products to list in a network-based marketplace.

FIG. 10 is a flow diagram of a method, in accordance with an embodiment, for recommending additional products or services related to a purchased product.

FIG. 11 is a network diagram depicting a client-server system within which an example embodiment may be deployed.

FIG. 12 is a block diagram of a machine in the example form of a computer system within which a set of instructions, for causing the machine to perform any one or more of the methodologies discussed herein, may be executed.

### DETAILED DESCRIPTION

Example systems and methods to generate and manage marketplace listings are described. In the following description, for purposes of explanation, numerous specific details are set forth in order to provide a thorough understanding of example embodiments. It will be evident, however, to one skilled in the art that the present invention may be practiced without these specific details.

The marketplace listing systems and methods described herein allow distributors (e.g., sellers) to list multiple items with a network-based marketplace without requiring the distributors to have detailed knowledge of the item listing procedures associated with the network-based marketplace. A catalog service provides product information used with a listing template to generate one or more marketplace listings. Additionally, distributor data is applied to the listing template based on the particular distributor requesting the marketplace listing. The described systems and methods further manage network-based marketplace listings based on distributor inventory data and other factors.

As used herein, a “distributor”, a “user” or an “entity” may be a person (e.g., a human), a business (e.g., a company), an organization, a group of people, a persona (e.g., a fictitious character), or any combination thereof. Although particular examples discussed herein refer to “products” listed with a network-based marketplace, the teachings of the present invention are applicable to any type of marketplace listing for any product, service, item, and the like.

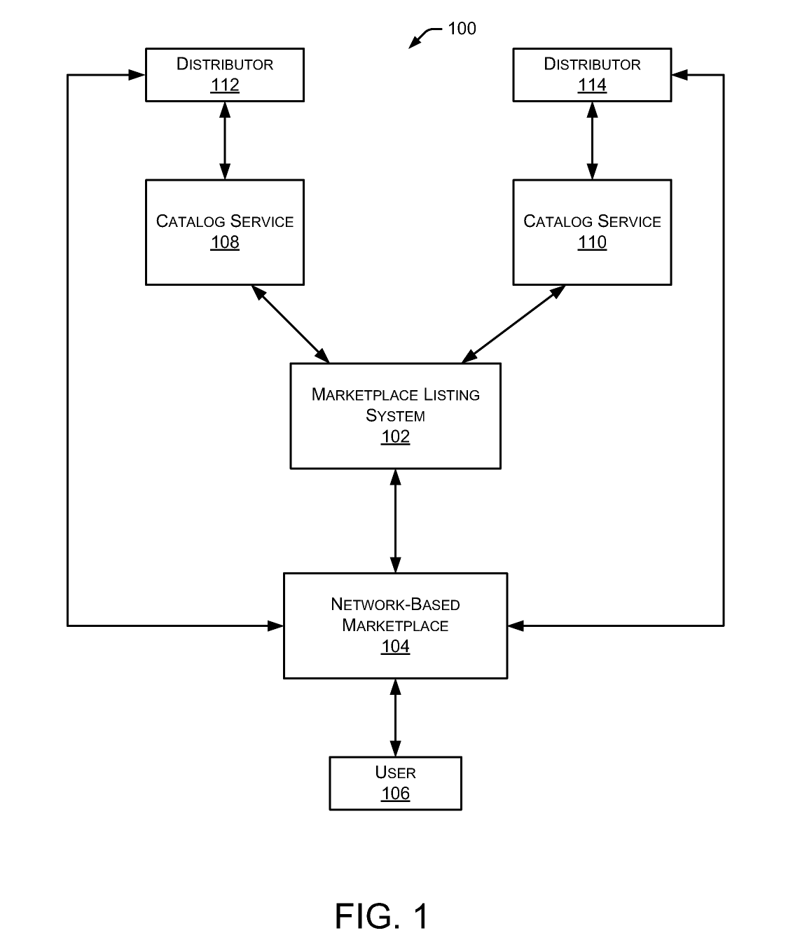

FIG. 1 is a block diagram depicting an example environment 100 capable of implementing the systems and methods discussed herein. A marketplace listing system 102 interacts with various other systems and devices (as described herein) to initiate and manage distributor product listings (also referred to as “marketplace listings”) on a network-based marketplace 104. Network-based marketplace 104 provides an electronic commerce marketplace for users to shop and perform various network-based transactions. Any number of users 106 can access network-based marketplace 104 through one or more data communication networks, such as the Internet. Similarly, marketplace listing system 102 is coupled to network-based marketplace 104 through one or more data communication networks.

Marketplace listing system 102 is also coupled to catalog services 108 and 110, which provide inventory management systems, product descriptions, and other services to distributors 112 and 114. Catalog services 108 and 110 may provide information and services related to thousands of different products that are physically maintained in warehouses or other facilities by multiple distributors. Each product associated with catalog service 108 or 110 has a unique product identifier or product code, such as a SKU (stock-keeping unit). In a particular embodiment, this unique product identifier is used by distributors, catalog services, manufacturers, and other entities throughout an industry. A catalog service is also referred to as a “catalog vendor”, an “electronic catalog service”, and an “online catalog service”. In particular embodiments, catalog services 108 and 110 are private catalog services that restrict access to particular distributors (e.g., distributors having registered with or subscribed to the catalog service). Although FIG. 1 illustrates two distributors 112 and 114, a particular catalog service may support any number of distributors. Further, a particular distributor may access multiple different catalog services.

Catalog services 108 and 110 allow each distributor associated with the catalog service to obtain product information (e.g., product photos, product descriptions, and product fitment data) related to the products offered by the distributor. Thus, instead of maintaining product information itself, the distributors retrieve product information and utilize other services through the catalog service. In a particular embodiment, catalog services 108 and 110 are private catalog services that restrict access to distributors that have subscribed to the catalog service. In this embodiment, the product information maintained by catalog services 108 and 110 is not publicly available.

In a particular implementation, marketplace listing system 102 communicates with catalog services 108 and 110 through one or more data communication networks, such as the Internet. Additionally, distributors 112 and 114 communicate with catalog services 108 and 110 through one or more data communication networks.

As shown in FIG. 1, distributors 112 and 114 also communicate directly with network-based marketplace 104. This communication is, for example, through one or more data communication networks. In a particular embodiment, distributors 112 and 114 communicate with network-based marketplace 104 to create and manage a user account with network-based marketplace 104. As discussed below, this user account allows distributors 112 and 114 to place listings on the network-based marketplace 104. Distributors 112 and 114 do not manually place listings with network-based marketplace 104. Instead, distributors 112 and 114 can utilize the automated marketplace listing procedures supported by marketplace listing system 102, as described herein.

Although FIG. 1 illustrates marketplace listing system 102 coupled to two catalog services 108 and 110, alternate embodiments may include a marketplace listing system coupled to any number of catalog services that each support any number of distributors. FIG. 1 illustrates marketplace listing system 102 as a separate system. In alternate embodiments, marketplace listing system 102 is incorporated into another system or device, such as network-based marketplace 104, catalog service 108 or catalog service 110.

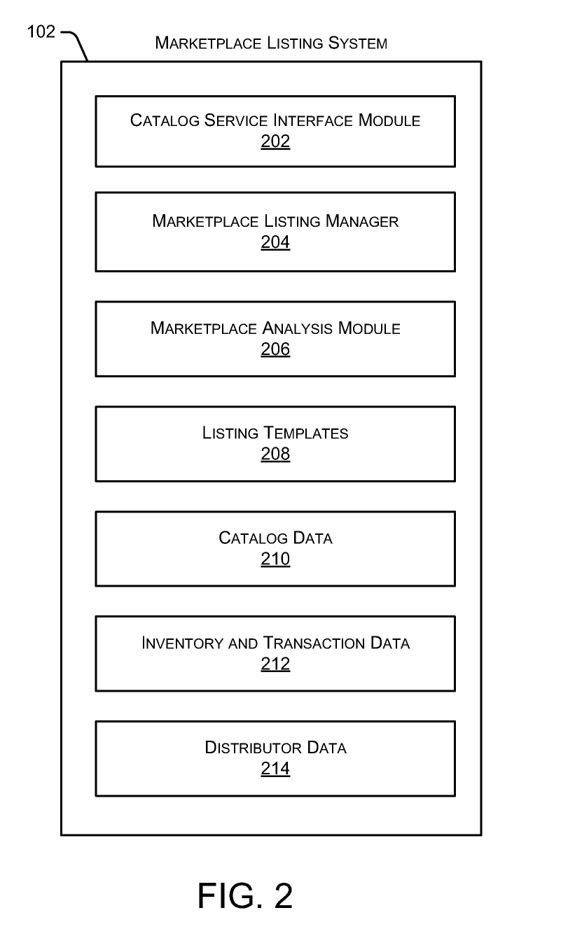

FIG. 2 is a block diagram of marketplace listing system 102, in accordance with some embodiments of the present invention. Marketplace listing system 102 may be executed or included in, for example, a server or other computing device. In various embodiments, marketplace listing system 102 implements computer programs, logic, applications, methods, processes, or software to perform the procedures discussed herein.

In the embodiment of FIG. 2, marketplace listing system 102 includes a catalog service interface module 202, a marketplace listing manager 204, and a marketplace analysis module 206. Catalog service interface module 202 is configured to communicate with one or more catalog services. For example, catalog service interface module 202 may receive data (e.g., product data) from the catalog services and send data (e.g., product sales related to marketplace listings) to the catalog services. Marketplace listing manager 204 is configured to communicate with one or more network-based marketplaces to, for example, initiate new listings, modify existing listings, and receive information regarding sales related to listings. Marketplace listing manager 204 also creates marketplace listings using one or more templates, as discussed below, in combination with various data used to complete the template. Marketplace analysis module 206 is configured to perform various types of analysis and evaluation of marketplace listings (e.g., current marketplace listings and completed marketplace listings). Marketplace analysis module 206 is further configured to generate recommendations regarding marketplace listings, such a pricing recommendations for a particular listing.

Marketplace listing system 102 also includes one or more listing templates 208, catalog data 210, inventory and transaction data 212, and distributor data 214. Listing templates 208 are standardized templates used to generate marketplace listings. The use of listing templates 208 provides a common listing format for all products associated with a particular catalog service, regardless of the distributor initiating the listing. Catalog data 210 includes, for example, product descriptions, product fitment data, product photos, and the like received from a catalog service or other data source. At least a portion of catalog data 210 is included when generating marketplace listings using listing templates 208. Inventory and transaction data 212 includes, for example, current inventory of a particular product by a specific distributor. Inventory and transaction data 212 also includes product sales data and product shipping information (e.g., shipping carrier and shipping status). Distributor data 214 includes, for example, a distributor's return policy, the distributor's geographic location, and a customer feedback rating associated with the distributor. At least a portion of distributor data 214 is included when generating marketplace listings using listing templates 208.

In particular embodiments, catalog service interface module 202, marketplace listing manager 204, and marketplace analysis module 206 may be in the form of software that is processed by a processor. In another example, catalog service interface module 202, marketplace listing manager 204, and marketplace analysis module 206 may be in the form of firmware that is processed by application specific integrated circuits (ASICs), which may be integrated into a circuit board. Alternatively, catalog service interface module 202, marketplace listing manager 204, and marketplace analysis module 206 may be in the form of one or more logic blocks included in a programmable logic device (e.g., a field programmable gate array (FPGA)). Further, one or more of catalog service interface module 202, marketplace listing manager 204, and marketplace analysis module 206 may be adapted, and/or additional structures used to provide alternative or additional functionalities beyond those specifically discussed herein.

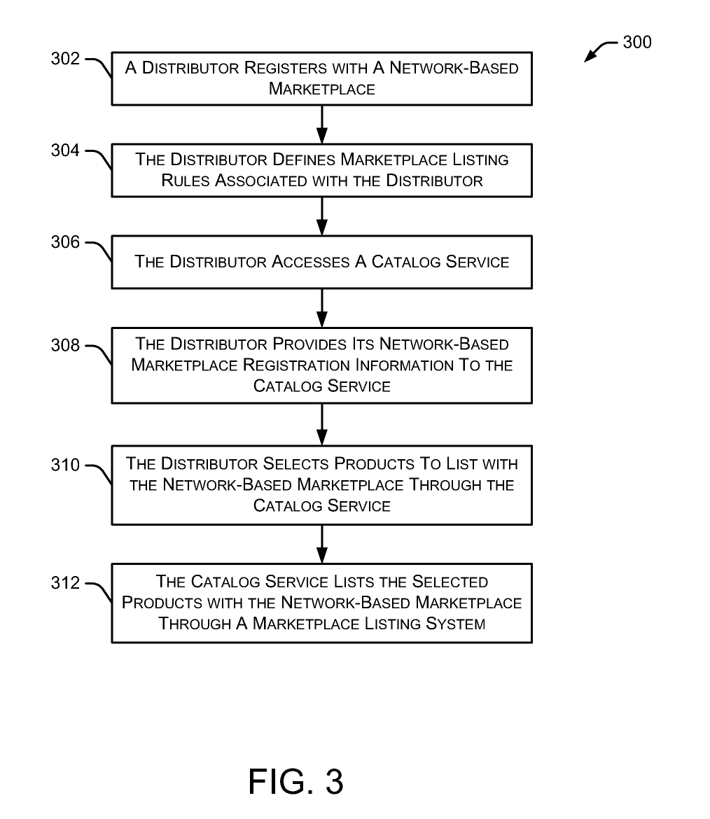

FIG. 3 is a flow diagram of a method 300, in accordance with an embodiment, for listing items with a network-based marketplace. In a particular embodiment, at least a portion of method 300 is implemented by a processor or computing system, such as one or more of the processors and computing systems discussed herein. Initially, a distributor registers with a network-based marketplace at 302. During the registration process, the distributor establishes an account with the network-based marketplace such that the distributor may later place listings in the marketplace. The distributor also defines marketplace listing rules and other information associated with the distributor (or the distributor's business) at 304. These listing rules include, for example, return policies, shipping policies, and the like. Additional information provided by the distributor may include the distributor's geographic location and types of payment accepted.

After registering with the network-based marketplace, the distributor accesses a catalog service at 306. In the example of FIG. 3, the distributor already had a relationship (e.g., membership) with the catalog service. In alternate embodiments, where the distributor does not have a relationship with the catalog service, the distributor subscribes to the catalog service prior to accessing the catalog at 306. After accessing the catalog service, the distributor provides its network-based marketplace registration information to the catalog service at 308. This registration information may include the distributor's user name and password associated with the network-based marketplace. The distributor's registration information is used at a later time to place listings on behalf of the distributor in the network-based marketplace.

To generate marketplace listings, the distributor selects one or more products to list with the network-based marketplace through the catalog service at 310. For example, the catalog service may provide a user interface that allows the distributor to identify specific products and define various parameters associated with the listings, such as price, shipping costs, and the like. The catalog service then lists the selected products with the network-based marketplace through a marketplace listing system at 312. As discussed herein, the marketplace listing system uses listing templates and other data received from the catalog service to generate listings for the products selected by the distributor. Once generated, the marketplace listing system communicates the listings to the network-based marketplace for placement in the marketplace.

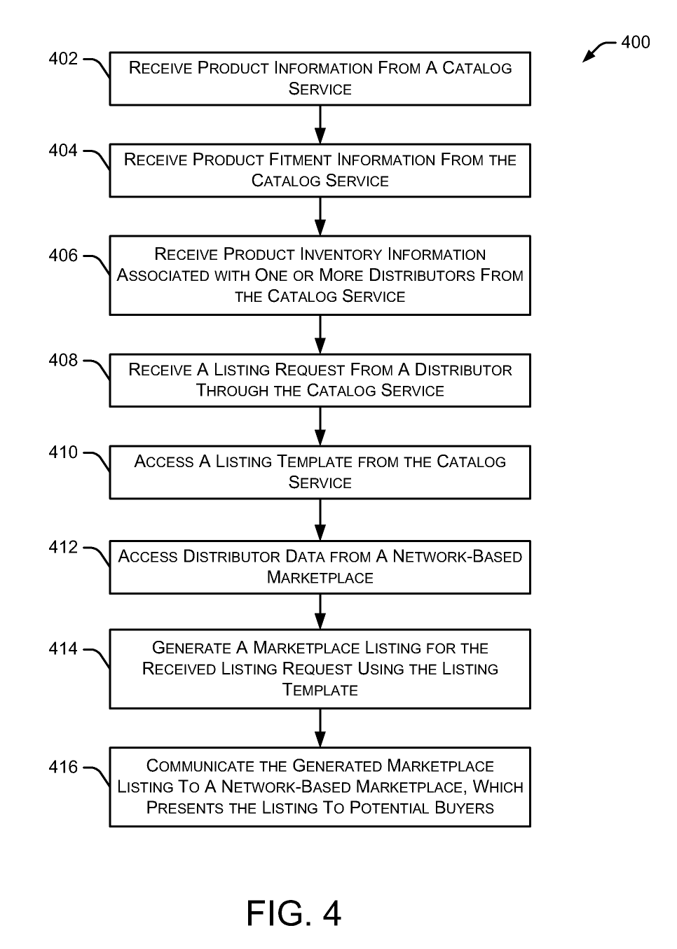

FIG. 4 is a flow diagram of a method 400, in accordance with an embodiment, for generating marketplace listings. In a particular embodiment, at least a portion of method 400 is implemented by a processor or computing system, such as one or more of the processors and computing systems discussed herein. In some embodiments, method 400 is implemented by marketplace listing system 102. Initially, a marketplace listing system receives product information from a catalog service at 402. The product information includes, for example, product descriptions, photographs, part numbers, and the like. Additionally, product fitment information is received from the catalog service at 404. The product fitment information includes systems or devices with which the product is operable. For example, if the product is a part for an automobile, the fitment information for that part may identify the specific car models and model years with which the part is designed to operate.

Method 400 continues as product inventory information associated with one or more distributors is received from the catalog service at 406. The product inventory information identifies an available quantity of the product from one or more distributors that are members of the catalog service. This inventory information may be included in the marketplace listing (e.g., indicating that a particular distributor has five pieces of a particular product available for sale). In particular embodiments, the product information, product fitment information, and product inventory information is stored by the marketplace listing system for generating marketplace listings at a future time. In other embodiments, the product information, product fitment information, and product inventory information is retrieved from the catalog service in response to receiving a listing request from a distributor that requires such information to generate the marketplace listing.

The method continues as the marketplace listing system receives a listing request from a distributor through the catalog service at 408. In response to the listing request, a listing template is accessed (e.g., retrieved) from the catalog service at 410. In an alternate embodiment, the listing template is retrieved from the catalog service during an initialization process (e.g., prior to receiving the listing request from the distributor). In this embodiment, the listing template is stored in the marketplace listing system. In certain implementations, the catalog service uses a common listing template for all items listed in or supported by the catalog service. This common listing template allows customization for a particular distributor by including a distributor name/logo, description of the distributor, and the like. In other implementations, the catalog service uses multiple listing templates and allows each distributor to select a preferred (or default) listing template for the distributor's listings.

After accessing the listing template, distributor data is accessed from a network-based marketplace at 412. The distributor data includes, for example, a return policy, warranty information, distributor logo, and the geographic location of the distributor. In one embodiment, the distributor data is provided by the distributor to the network-based marketplace when the distributor registers (i.e., establishes an account) with the network-based marketplace. In an alternate embodiment, the distributor data is accessed from a catalog service or other data source.

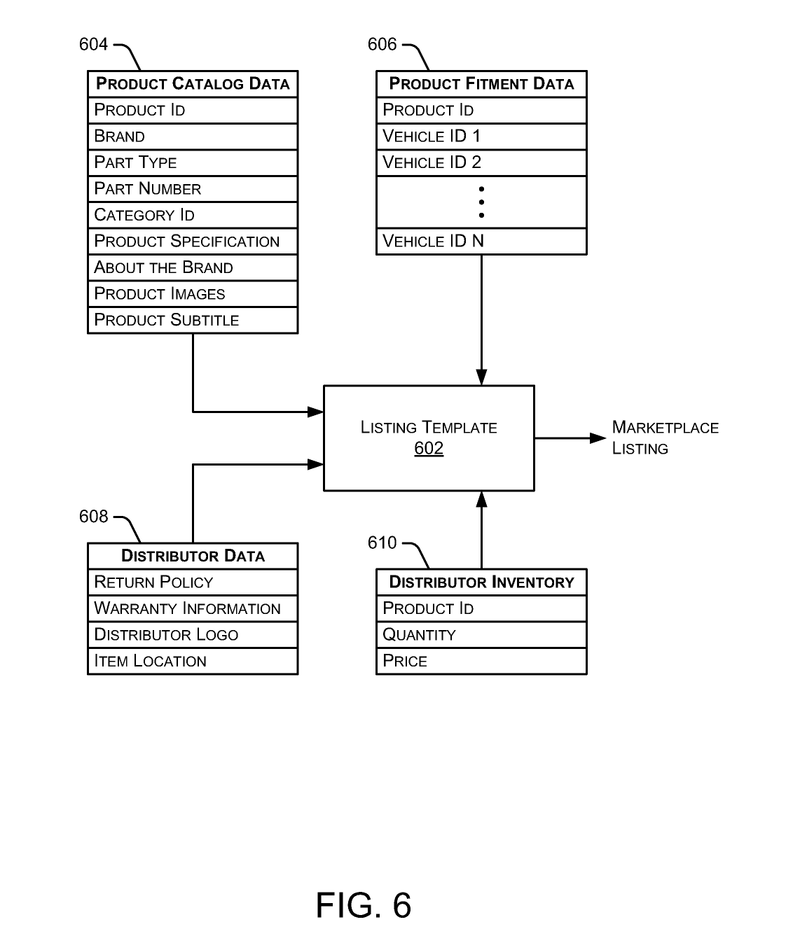

A marketplace listing is then generated using the listing template at 414. As discussed in greater detail below with respect to FIG. 6, the listing template combines product information, product fitment information, product inventory information, and distributor data into a marketplace listing. By using the listing template, a common marketplace listing format is generated for all products associated with a particular catalog service, regardless of the distributor generating the listing request. Finally, the marketplace listing is communicated to a network-based marketplace at 416, which presents the listing to potential buyers (e.g., users of the network-based marketplace).

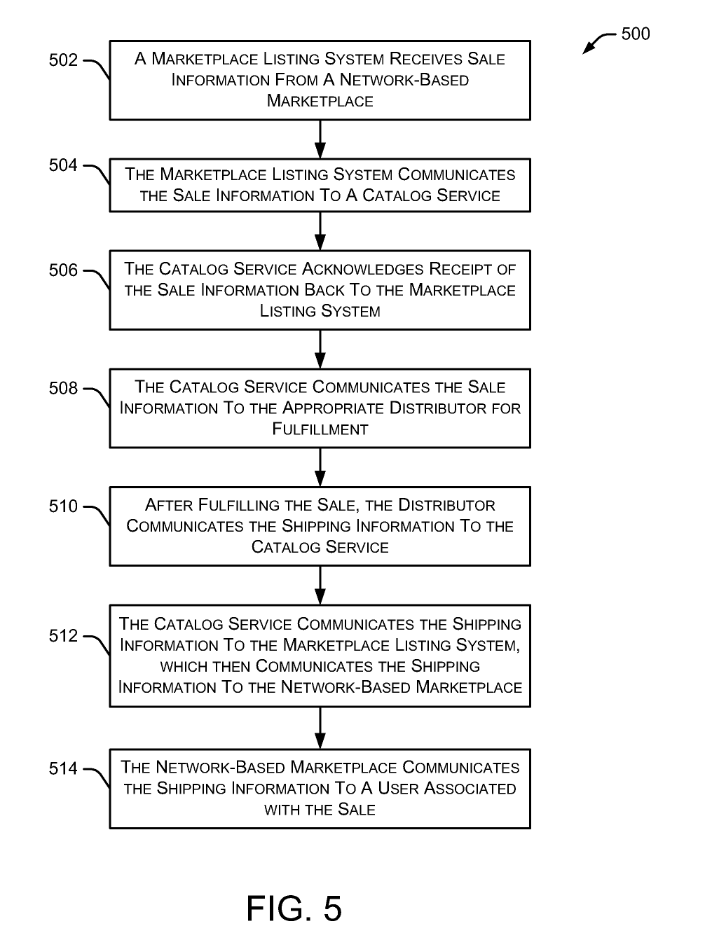

FIG. 5 is a flow diagram of a method 500, in accordance with an embodiment, for communicating sale and shipping information associated with items listed with a network-based marketplace. In a particular embodiment, at least a portion of method 500 is implemented by a processor or computing system, such as one or more of the processors and computing systems discussed herein. Initially, a marketplace listing system receives sale information from a network-based marketplace at 502. For example, marketplace listing system 102 (FIG. 1) receives sale information from network-based marketplace 104 for a marketplace listing generated by the marketplace listing system. The sale information is associated with a particular distributor (i.e., the distributor that generated the original listing request through a catalog service). The sale information may include a listing number (or other identifier uniquely identifying the listing), a sale price, information associated with a user that purchased the product, and the like.

The marketplace listing system communicates the sale information to a catalog service at 504 (e.g., the catalog service that communicated the original listing request to the marketplace listing system). The catalog service acknowledges receipt of the sale information back to the marketplace listing system at 506. Since the marketplace listing system does not communicate directly with the distributor, this acknowledgement is important for confirming to the marketplace listing system that the sale information was received and is being handled by the catalog service. The catalog service communicates the sale information to the appropriate distributor (e.g., the distributor that generated the original listing request) for fulfillment at 508.

After the distributor fulfills the sale (e.g., ships the product to a user associated with the sale), the distributor communicates the shipping information to the catalog service at 510. The shipping information includes, for example, the shipping company, a shipping or tracking number, expected delivery date, and the shipping service level (e.g., ground, expedited service or freight). The catalog service communicates the shipping information to the marketplace listing system, which then communicates the shipping information to the network-based marketplace at 512. Finally, the network-based marketplace communicates the shipping information to a user associated with the sale at 514. The shipping information confirms the completed sale to the various systems and components involved in the listing transaction (i.e., the catalog service, the marketplace listing system, and the network-based marketplace).

FIG. 6 depicts, in accordance with an embodiment, example data associated with a listing template 602. As discussed above, listing template 602 receives various data and generates a marketplace listing based on the received data. Listing template 602 can be used with all products associated with a particular catalog service, or used with specific types (or groups) of products. For example, one listing template is used for automotive parts that have specific fitment data (e.g., brake parts and engine parts) and another listing template is used for automotive parts that do not have associated fitment data (e.g., car wax and engine oil). In a particular embodiment, listing template 602 is used with products from multiple different catalog services.

In the example of FIG. 6, listing template 602 receives product catalog data 604, which includes data about products received from a catalog service or other data source. Each product has associated data including a product ID (e.g., a unique code or other identifier), a brand, a part type, a part number, a category ID, a product specification, information about the brand, product images, and a product subtitle.

Listing template 602 also receives product fitment data 606 from a catalog service or other data source. Product fitment data 606 identifies a product ID (the same product ID contained in product catalog data 604), and multiple vehicles on which the product is appropriate or operable. In the example of FIG. 6, the product is a part for a vehicle. Thus, product fitment data 606 identifies specific vehicles on which the part will operate. In one embodiment, the vehicles are identified by manufacturer, model, and model year. In other embodiments, product fitment data 606 is associated with any type of product usage information.

Listing template 602 additionally receives distributor data 608 from a catalog service, a network-based marketplace, or another data source. Distributor data 608 includes a return policy associated with products purchased from the distributor, warranty information, a logo associated with the distributor's business, and an item location (e.g., a geographic location from which the product is shipped). Listing template 602 further receives distributor inventory data 610 from a catalog service or other data source. Distributor inventory data 610 includes a product ID (the same product ID contained in product catalog data 604 and product fitment data 606), a quantity (e.g., the current quantity available for sale by the distributor), and a price.

The various data received by listing template 602 is arranged as defined by the listing template. The same listing template is used for generating marketplace listings for multiple products from multiple distributors. Thus, a common listing format is produced for all marketplace listings generated using listing template 602. This common listing format provides a uniform buying experience that allows users to more easily identify information associated with a product of interest.

In a particular embodiment, listing template 602 identifies one or more required fields, such as product ID, return information, and price. Data associated with these required fields must be received before the listing template is able to generate a marketplace listing. In this embodiment, certain fields in listing template 602 are flagged as “required” fields, which must be filled to generate a marketplace listing. Other fields in listing template 602 may be “optional” fields (e.g., product images and product subtitle) that are not required to generate a marketplace listing.

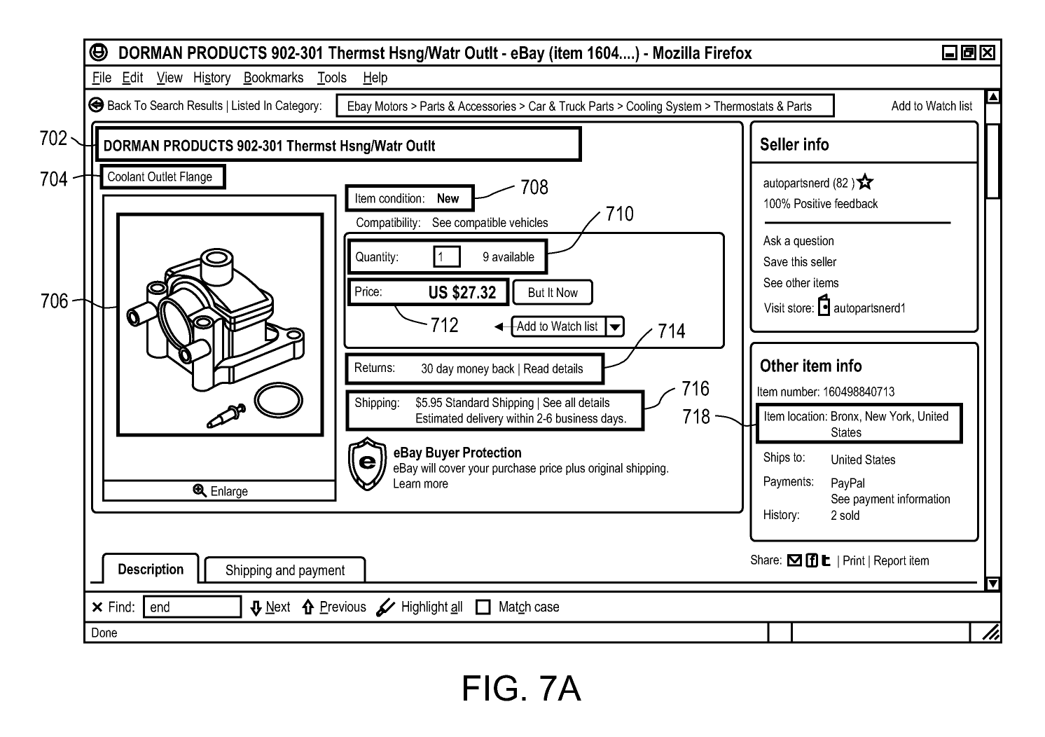

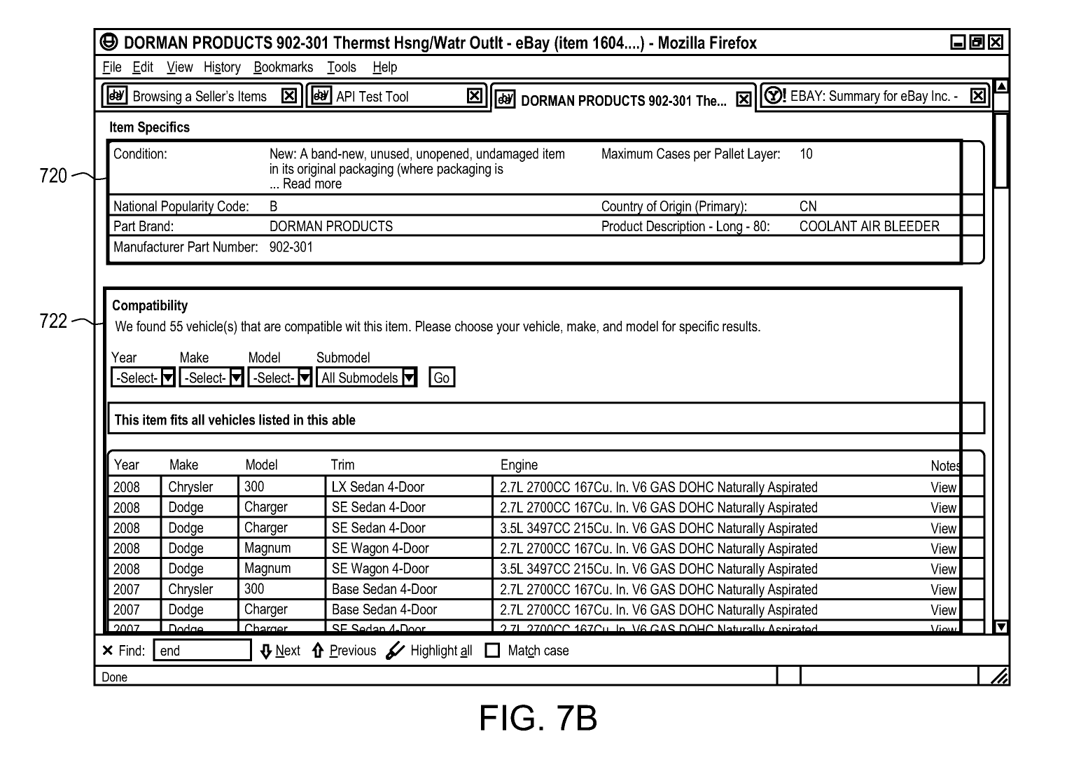

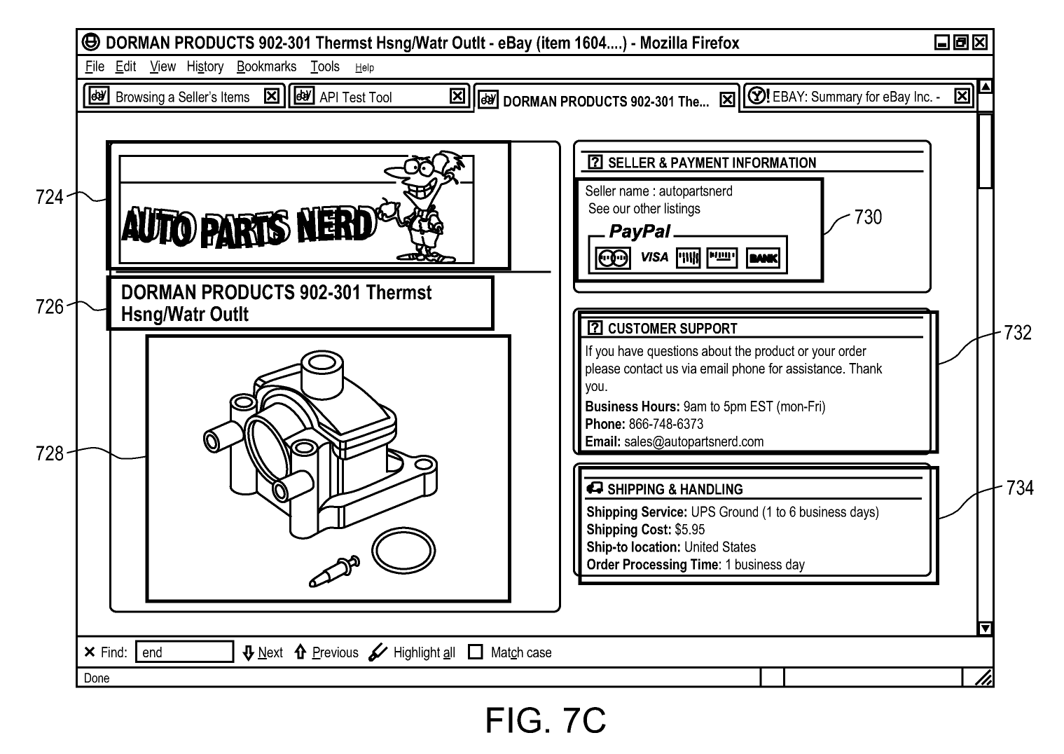

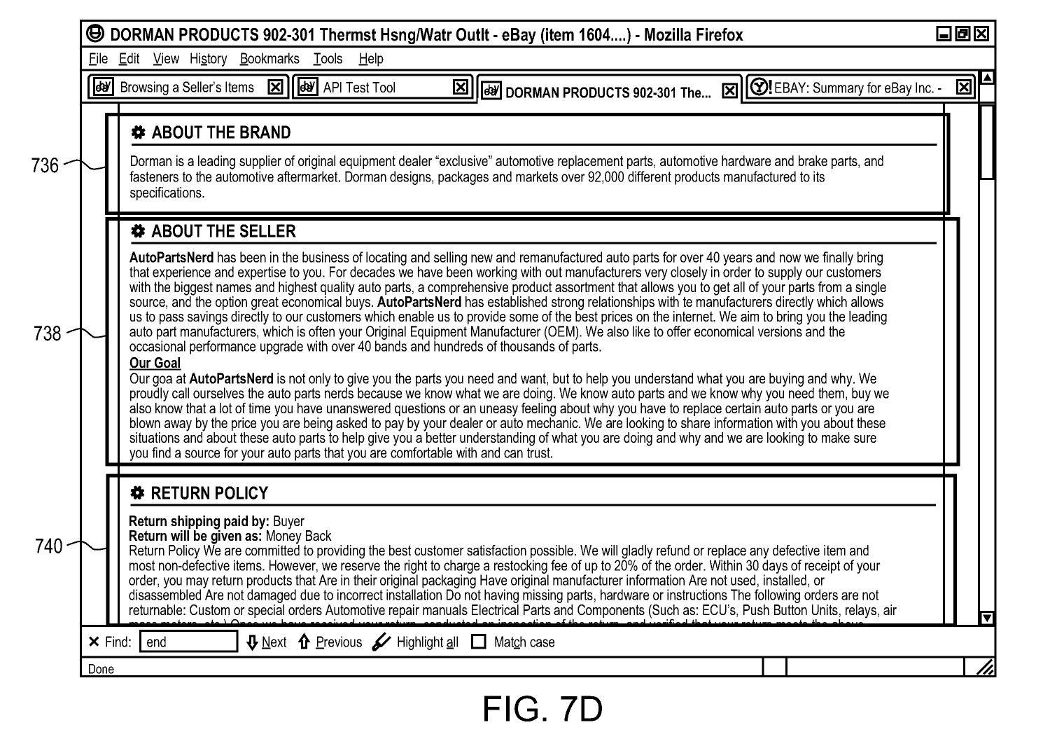

FIGS. 7A-7D depict, in accordance with an embodiment, various portions of an example marketplace listing generated using a listing template of the type discussed above with respect to FIG. 6. FIG. 7A depicts a top portion of a marketplace listing including a brand and part type 702, a product subtitle 704 and a product image 706. Additionally, the marketplace listing of FIG. 7A depicts inventory data that includes a quantity 710 and a price 712. FIG. 7A also depicts distributor-related data, which includes a product condition 708, a return policy 714, shipping details 716 and an item location 718.

FIG. 7B depicts another portion of the marketplace listing, which includes product details 720 and product fitment data 722. FIG. 7C depicts additional information contained in the marketplace listing, including a distributor logo 724, a product name and part number 726, a product image 728, a distributor name and payment options 730, distributor customer support information 732, and shipping details 734. FIG. 7D depicts product brand information 736, distributor information 738, and a return policy 740.

As discussed above with respect to FIG. 6, various types of data are received and applied to listing template 602 to generate marketplace listings. In a particular embodiments, different types of data are updated at different frequencies. For example, product catalog data is updated approximately once per month, product fitment data is updated approximately once every three months, distributor inventory data is updated on a daily basis, sales activity is updated approximately once per day, and shipping confirmations are updated approximately once per day.

Each time data is updated, active marketplace listings are analyzed to determine whether any listings need to be modified or deleted based on the updated data. For example, if a distributor's inventory for a particular product has been depleted, any of the distributor's active marketplace listings for that depleted product should be deleted. Alternatively, the active marketplace listings for the depleted product can be suspended (e.g., temporarily deactivated) until the distributor's inventory is replenished.

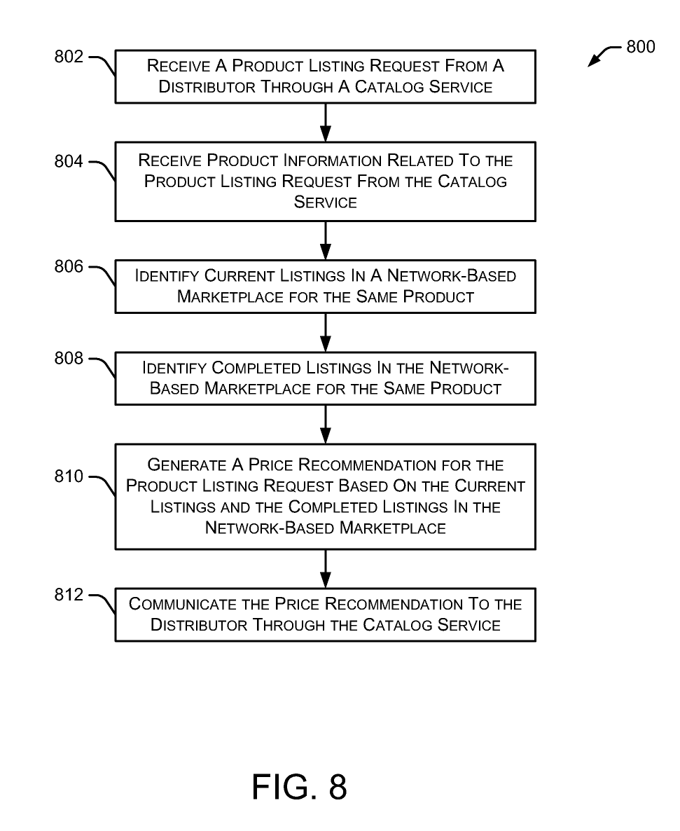

FIG. 8 is a flow diagram of a method 800, in accordance with an embodiment, for generating price recommendations for marketplace listings. In a particular embodiment, at least a portion of method 800 is implemented by a processor or computing system, such as one or more of the processors and computing systems discussed herein. In some embodiments, method 800 is implemented by marketplace listing system 102. Initially, a product listing request is received from a distributor through a catalog service at 802. The product listing request identifies at least one product available from the distributor. Product information related to the product listing request is received (e.g., accessed) from the catalog service at 804. As discussed herein, the product information may include a product description, product ID, product image, fitment information, and the like.

Method 800 continues by identifying current listings in a network-based marketplace for the same product at 806. These current listings are identified, for example, using a unique product ID or other information that identifies the product associated with the distributor's listing request. When identifying current listings for the product, the method may identify, for example, the number of current listings, the prices associated with those listings, and the ratings of sellers associated with the listings. The method also identifies completed listings in the network-based marketplace for the same product at 808. In a manner similar to identifying current listings, the completed listings are identified using information that uniquely identifies the product. When identifying completed listings, the method may identify, for example, the number of completed listings, the selling price for those listings, and the ratings of sellers associated with the listings.

The method generates a price recommendation for the product listing request based on the current listings and the completed listings in the network-based marketplace at 810. The price recommendation represents a price for the product that is competitive in the network-based marketplace based on actual selling prices for completed listings as well as the current prices for the same product in the network-based marketplace. The price recommendation can be a specific price, such as $10.50, or a range of prices, such as $10.00-11.25. The price recommendation is communicated to the distributor through the catalog service at 812. The distributor then selects a price associated with the product in the listing request. The selected price may be the price recommended by method 800 or a different price selected solely by the distributor. After the price is selected, and all other listing details are provided, a listing is generated and communicated to the network-based marketplace, as discussed herein.

In a particular embodiment, price recommendations for marketplace listings are generated by identifying a lowest, average, and highest selling price for a particular product during a period of time (e.g., the last 90 days). This pricing data is used to generate a recommended price (or range of prices) for the product. If no pricing data is available for the period of time (e.g., no sales in the last 90 days), the recommended price is based on a suggested list price for the product or similar information. When identifying the lowest, average, and highest selling price for a product, the marketplace listing system may consider pricing data associated with a single catalog service or may consider pricing data associated with multiple catalog services.

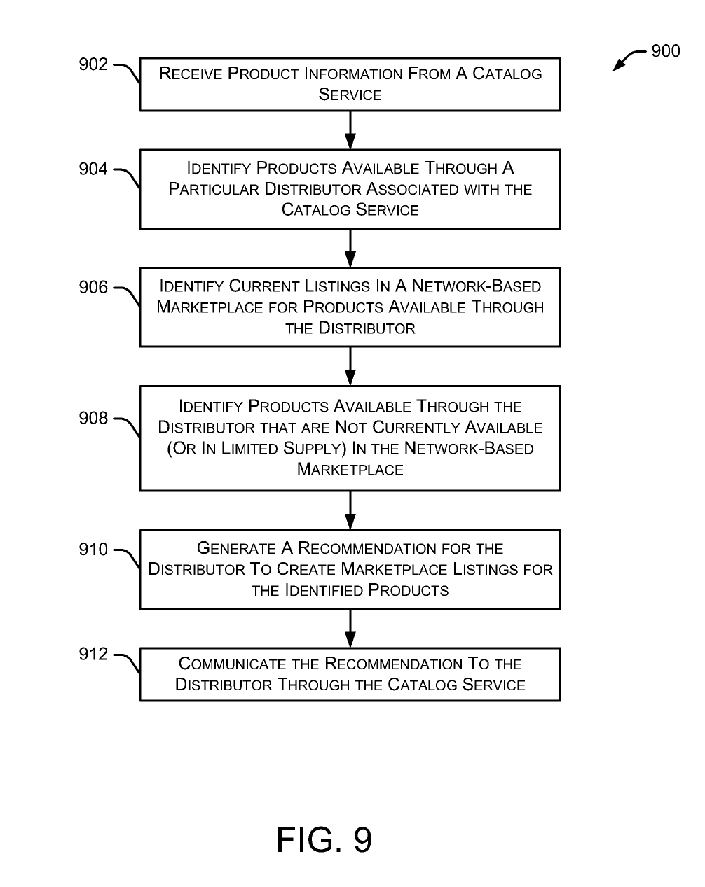

FIG. 9 is a flow diagram of a method 900, in accordance with an embodiment, for recommending products to list in a network-based marketplace. In a particular embodiment, at least a portion of method 900 is implemented by a processor or computing system, such as one or more of the processors and computing systems discussed herein. In some embodiments, method 900 is implemented by marketplace listing system 102. Initially, product information is received from a catalog service at 902. Using the received product information, the method identifies products available through a particular distributor associated with the catalog service at 904. A particular distributor may offer any number of different products described by (or supported by) a particular catalog service.

Method 900 continues by identifying current listings in a network-based marketplace for products that are available through the distributor at 906. Based on those current listings, the method identifies products available through the distributor that are not currently available (or are currently in limited supply) in the network-based marketplace at 908. A recommendation is generated for the distributor to create marketplace listings for the identified products at 910 (i.e., the products not currently available or in limited supply in the network-based marketplace. The recommendation is then communicated to the distributor through the catalog service at 912. Thus, method 900 identifies “gaps” or opportunities within the network-based marketplace that can be filled by the distributor based on the distributor's current inventory of specific products. In a particular embodiment, the recommendations to fill “gaps” in the network-based marketplace are communicated to multiple distributors through one or more catalog services. This embodiment allows multiple distributors to provide the product listings that fill the network-based marketplace gaps.

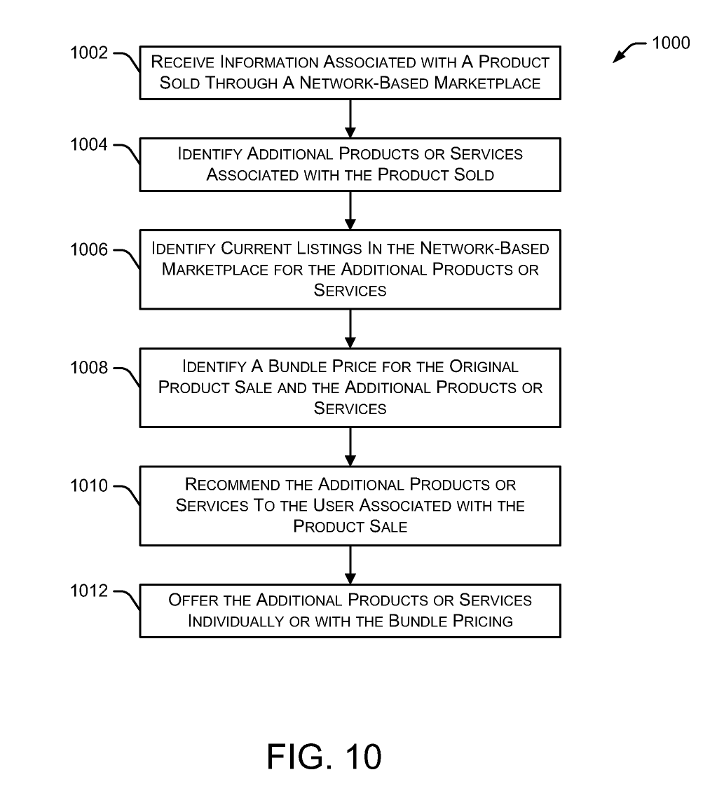

FIG. 10 is a flow diagram of a method 1000, in accordance with an embodiment, for recommending additional products or services related to a purchased product. In a particular embodiment, at least a portion of method 1000 is implemented by a processor or computing system, such as one or more of the processors and computing systems discussed herein. In some embodiments, method 1000 is implemented by marketplace listing system 102. Initially, the method receives information associated with a product sold through a network-based marketplace at 1002. For example, the product sale information is related to a sale transaction for a product listing on the network-based marketplace. The product sale information may include a product ID, a purchase price, and the identity of a user or entity purchasing the product. In particular embodiments, the product sale transaction is not yet finalized, such that additional products or services can be added to the same transaction.

After receiving the product sale information, method 1000 identifies additional products or services associated with the product sold at 1004. Additional products or services include, for example, related parts, installation kits or tools, gaskets, sealants, lubricants or other items specifically related to the product purchased. For example, if the user purchases a new alternator for a vehicle, the additional product may include a replacement belt for the alternator as well as a wrench or other tool to assist with the replacement of the alternator and/or belt. In another example, if the product sold is a vehicle tire, an additional product may include a valve stem and an additional service may include mounting and balancing the tire on a vehicle wheel. Similarly, if a user purchases a digital camera, additional products may include a memory card, carrying case, and tripod for the camera.

In a particular embodiment, the additional products or services are identified from a catalog service (e.g., 108 or 110 in FIG. 1). In this embodiment, the catalog service contains information regarding additional products or services that can be purchased with a particular product. Thus, the identity of the product sold is used to access product information from the catalog service, which includes additional products or services. In another embodiment, additional products or services are identified based on previous purchases by other buyers. For example, if other buyers of a digital camera have purchased a memory card for the camera, one or more memory cards are offered to the user who is purchasing a digital camera.

The method continues by identifying current listings in the network-based marketplace for the additional products or services at 1006. Based on the current listings for additional products or services, a bundle price is generated at 1008 that includes the original product sold and the additional products or services. In a particular implementation, the bundle price is lower than the total price of purchasing the products/services individually. Additionally, the bundle price may include products from multiple distributors or sellers. For example, if a user purchases an alternator for a vehicle from one distributor, a replacement belt for the alternator may be offered from a different distributor. When the alternator and replacement belt are bundled together, the bundle price is less than the total cost of purchasing the alternator and replacement belt separately. In particular embodiments, distributors agree to certain predefined discount rules (e.g., discounting additional products or services by 10%) prior to listing products with the marketplace.

Method 1000 recommends the additional products or services to the user associated with the product sale at 1010. In one example, the additional products or services are recommended prior to completing the sale (e.g., before the user finalizes payment for the purchased product). In different embodiments, the additional products or services are recommended individually or with bundle pricing at 1012. In a specific embodiment, the additional products are offered both individually and as a bundle. In this embodiment, the user can choose whether to purchase specific additional products or purchase the entire bundle.

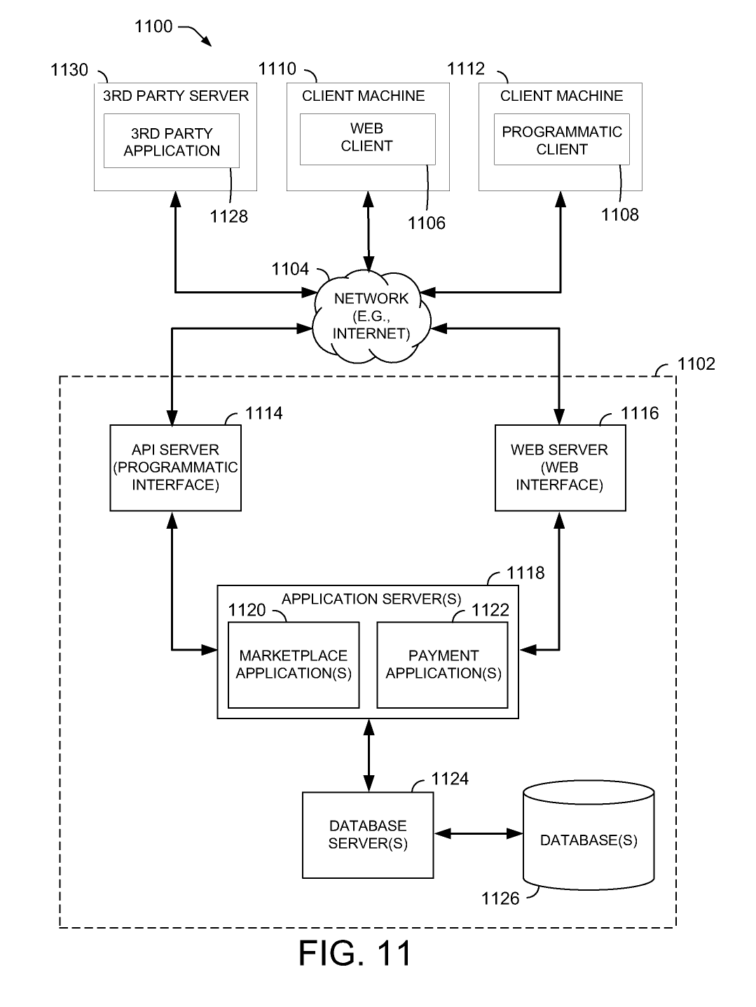

FIG. 11 is a network diagram depicting a client-server system 1100, within which one example embodiment may be deployed. A networked system 1102, in the example form of a network-based marketplace or publication system, provides server-side functionality, via a network 1104 (e.g., the Internet or Wide Area Network (WAN)) to one or more clients. FIG. 11 illustrates, for example, a web client 1106 (e.g., a browser, such as the Internet Explorer browser developed by Microsoft Corporation of Redmond, Wash.), and a programmatic client 1108 executing on respective client machines 1110 and 1112.

An Application Programming Interface (API) server 1114 and a web server 1116 are coupled to, and provide programmatic and web interfaces respectively to, one or more application servers 1118. Application servers 1118 host one or more marketplace applications 1120 and payment applications 1122. Application servers 1118 are, in turn, shown to be coupled to one or more database servers 1124 that facilitate access to one or more databases 1126.

Marketplace applications 1120 may provide a number of marketplace functions and services to users that access networked system 1102. Payment applications 1122 may likewise provide a number of payment services and functions to users. Payment applications 1122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 1120. While the marketplace and payment applications 1120 and 1122 are shown in FIG. 11 to both form part of networked system 1102, it will be appreciated that, in alternative embodiments, payment applications 1122 may form part of a payment service that is separate and distinct from networked system 1102.

Further, while the system 1100 shown in FIG. 11 employs a client-server architecture, the present invention is of course not limited to such an architecture, and could equally well find application in a distributed, or peer-to-peer, architecture system, for example. The various marketplace and payment applications 1120 and 1122 could also be implemented as standalone software programs, which do not necessarily have networking capabilities.

Web client 1106 accesses the various marketplace and payment applications 1120 and 1122 via the web interface supported by web server 1116. Similarly, programmatic client 1108 accesses the various services and functions provided by the marketplace and payment applications 1120 and 1122 via the programmatic interface provided by API server 1114. Programmatic client 1108 may, for example, be a seller application (e.g., the TurboLister application developed by eBay Inc., of San Jose, Calif.) to enable sellers to author and manage listings on networked system 1102 in an off-line manner, and to perform batch-mode communications between programmatic client 1108 and networked system 1102. Some embodiments of the present invention may be implemented by components of the marketplace application(s) 1120.

FIG. 11 also illustrates a third party application 1128, executing on a third party server machine 1130, as having programmatic access to networked system 1102 via the programmatic interface provided by API server 1114. For example, third party application 1128 may, utilizing information retrieved from networked system 1102, support one or more features or functions on a website hosted by the third party. The third party website may, for example, provide one or more promotional, marketplace or payment functions that are supported by the relevant applications of the networked system 1102.

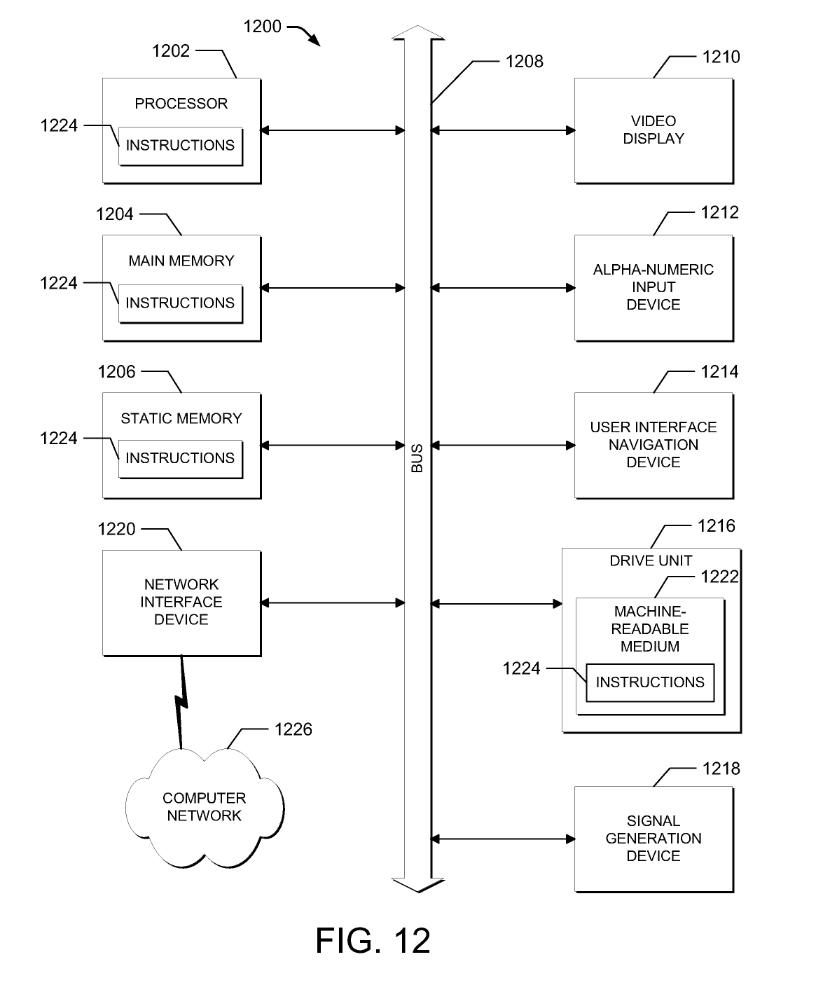

FIG. 12 shows a diagrammatic representation of machine in the example form of a computer system 1200 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU) a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a cursor control device 1214 (e.g., a mouse), a disk drive unit 1216, a signal generation device 1218 (e.g., a speaker) and a network interface device 1220.

The disk drive unit 1216 includes a machine-readable storage medium 1222 on which is stored one or more sets of instructions (e.g., software) 1224 embodying any one or more of the methodologies or functions described herein. The software 1224 may also reside, completely or at least partially, within the main memory 1204, within the static memory 1206, and/or within the processor 1202 during execution thereof by the computer system 1200, the main memory 1204 and the processor 1202 also constituting machine-readable media. The software 1224 may further be transmitted or received over a network 1226 via the network interface device 1220.

While the machine-readable storage medium 1222 is shown in an example embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing, encoding or carrying a set of instructions for execution by the machine and that cause the machine to perform any one or more of the methodologies of the present invention. The term “machine-readable storage medium” shall accordingly be taken to include, but not be limited to, solid-state memories, optical and magnetic media, and carrier wave signals.

Thus, a method and system for generating marketplace listings have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

In the foregoing description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the description, with each claim standing on its own as a separate embodiment.

1. A method comprising:
receiving from a catalog service a product listing request identifying a product associated with the catalog service, the product listing request initiated by a distributor associated with the catalog service;
identifying current listings for the product in a network-based marketplace;
identifying completed listings for the product in the network-based marketplace; and
generating, using one or more processors, a price recommendation for the product listing request based on the current listings and the completed listings.

2. The method of claim 1, further comprising communicating the price recommendation to the distributor through the catalog service.

3. The method of claim 1, further comprising generating a marketplace listing based on the product listing request and the price recommendation.

4. The method of claim 3, further comprising communicating the marketplace listing to a network-based marketplace.

5. The method of claim 1, wherein the catalog service provides product information associated with a plurality of products manufactured by a plurality of entities.

6. The method of claim 1, further comprising receiving product information associated with the product from the catalog service, the product information including a unique identifier associated with the product.

7. The method of claim 1, further comprising:
receiving a listing template associated with the product from the catalog service; and
generating a marketplace listing based on the product listing request, the listing template, and the price recommendation.

8-16. (canceled)

17. A system comprising:
an interface module configured to access product information from a catalog service coupled to the system; and
a marketplace listing manager, implemented using one or more processors, configured to receive a product listing request from the catalog service that identifies a product associated with the catalog service, the marketplace listing manager to identify current listings for the product and identify completed listings for the product in a network-based marketplace, the marketplace listing manager further to generate a price recommendation for the product listing request based on the current listings and the completed listings.

18. The system of claim 17, wherein the interface module is further to communicate the price recommendation to the distributor through the catalog service.

19. The system of claim 17, wherein the marketplace listing manager is further to generate a marketplace listing based on the product listing request and the price recommendation.

20. The system of claim 19, wherein the marketplace listing manager is further to communicate the marketplace listing to a network-based marketplace.

21. A method comprising:
receiving from a catalog service a product listing request identifying a product associated with the catalog service, the product listing request initiated by a distributor associated with the catalog service;
identifying current listings for the product in a network-based marketplace;
identifying completed listings for the product in the network-based marketplace, for each of the completed listings:
identifying a selling price for the completed listing; and
identifying a seller rating for the completed listing;
generating, using one or more processors, a price recommendation for the product listing request based on the current listings, the selling prices for the completed listings, and the seller ratings for the completed listings.

22. The method of claim 21, wherein identifying completed listings for the product in the network-based marketplace further includes identifying a number of completed listings for the product in the network-based marketplace.

23. The method of claim 21, wherein identifying current listings for the product in the network-based marketplace includes:
identifying a listing price for each of the current listings; and
identifying a seller rating for each of the current listings.

24. The method of claim 21, wherein identifying current listings for the product in the network-based marketplace includes:
identifying a number of current listings;
identifying a listing price for each of the current listings; and
identifying a seller rating for each of the current listings.

25. The method of claim 21, wherein identifying completed listings for the product in the network-based marketplace further includes identifying a lowest selling price, an average selling price, and a highest selling price for the completed listings.

26. The method of claim 25, wherein generating the price recommendation for the product listing request is further based on the lowest selling price, the average selling price, and the highest selling price for the completed listings.

27. The method of claim 1, wherein identifying completed listings for the product in the network-based marketplace includes:
identifying a lowest selling price, an average selling price, and a highest selling price for each of the completed listings; and
identifying a seller rating for each of the completed listings.

28. The method of claim 27, wherein generating the price recommendation for the product listing request is further based on the lowest selling price, the average selling price, and the highest selling price for the completed listings.

29. The method of claim 1, wherein identifying completed listings for the product in the network-based marketplace includes:
identifying a number of completed listings;
identifying a lowest selling price, an average selling price, and a highest selling price for each of the completed listings; and
identifying a seller rating for each of the completed listings.
